(19) United States
(12) Patent Application Publication
(10) Pub. No.: US 2016/0043581 A1
(43) Pub. Date: Feb. 11, 2016

(54) CONTROLLER FOR BATTERY SYSTEM

(71) Applicant: DENSO CORPORATION, Kariya-city (JP)

(72) Inventor: Akira ITO, Nukata-gun (JP)

(21) Appl. No.: 14/818,398

(22) Filed: Aug. 5, 2015

(30) Foreign Application Priority Data
Aug. 8, 2014 (JP) 2014-162634

(51) Int. Cl. H02J 7/00

(52) U.S. Cl. CPC H02J 7/0021; H02J 7/007

(57) ABSTRACT

A target setting portion establishes a target charge/discharge amount which a battery system charges or discharges during a predetermined charge-and-discharge period. A stop selection portion selects the battery device to be stopped based on the target charge/discharge amount. During the predetermined charge-and-discharge period, the battery device which is selected by the stop selection portion is stopped and the other battery devices are charged or discharged.

### CROSS-REFERENCE TO RELATED APPLICATION

This application is based on Japanese Patent Application No. 2014-162634 filed on Aug. 8, 2014, the disclosure of which is incorporated herein by reference.

### TECHNICAL FIELD

The present disclosure relates to a controller for a battery system which is provided with multiple battery devices.

### BACKGROUND

Electric power supplied to a building from an electric power system is significantly varied according to a work situation of a power-use equipment in the building. JP-2012-257406A shows that a factory is equipped with a battery system for equalizing the electric power supplied from an electric power system (peak cut).

In the battery system, the electric power is stored in a battery during a time period in which an electric power usage is little, for example, night time. During a period in which an electric power usage is large, the electric power is supplied from the battery. Thus, a maximum value of the electric power supplied from an electric power system can be restricted, so that electric charges can be suppressed.

Generally, the battery has a capacity according to the scale of a building. That is, the battery system for a large building is equipped with a large-capacity battery, and the battery system for a small building is equipped with a small-capacity battery. However, in such a configuration, plurality kinds of battery systems are necessary according to the scale of the building.

The present inventor has been developing a battery system having a plurality of battery devices each of which is a unit including a battery and other components, for example, a power conversion apparatus. The number of the battery devices is adjusted according to the scale of the building, so that the capacity of the battery in the battery system can be made appropriate. That is, it is unnecessary to prepare multiple batteries of which capacity is different from each other.

Each battery device is a system equipped with a control circuit, a power conversion apparatus and the like. Each battery device consumes the electric power (standby energy) for operating the system. Thus, the electric power is consumed in proportion to the number of the battery devices which are operating. Especially, in the case that the battery system is provided to a large-scale building, the number of the battery devices is increased and the electric power consumption of the battery system is increased.

Moreover, the electric power outputted and inputted to each battery becomes small. That is, the electric power inputted into each battery at the time of electric charging becomes small, and the electric power outputted from each battery at the time of electric discharging become small. As a result, an operating efficiency of a power conversion apparatus provided to the battery device is deteriorated. It is likely that a part of the electric power stored in the battery becomes useless due to a conversion loss.

Thus, in a battery system having multiple battery devices, it is likely that an operating efficiency of the whole system may be deteriorated due to an increase in electric power consumption or a deterioration in operating efficiency of a power conversion apparatus.

### SUMMARY

It is an object of the present disclosure to provide a controller which is able to operate a battery system at high efficiency, which has multiple battery devices.

According to the present disclosure, a controller for a battery system has a target setting portion establishing a target charge/discharge amount which the battery system charges or discharges during a predetermined charge-and-discharge period; and a stop selection portion selecting the battery device to be stopped based on the target charge/discharge amount. During the predetermined charge-and-discharge period, the battery device which is selected by the stop selection portion is stopped and the other battery devices are charged or discharged.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a power system diagram showing a battery system;

FIG. 2 is a control block diagram for explaining functional blocks of the controller;

FIG. 3 is a flow chart showing a processing which a controller performs;

FIG. 4 is a chart for explaining a queue which the controller establishes;

FIG. 5 is a flow chart showing a processing which a controller performs for charging;

FIG. 6 is a chart for explaining an update process of the queue at electric charging;

FIG. 7 is a flow chart showing a processing which a controller performs for discharging;

FIG. 8 is a chart for explaining an update process of the queue at electric discharging; and

FIG. 9 is a graph showing a relation between a load factor and an efficiency in a DC-DC converter.

### DETAILED DESCRIPTION

Referring to drawings, an embodiment will be described hereinafter.

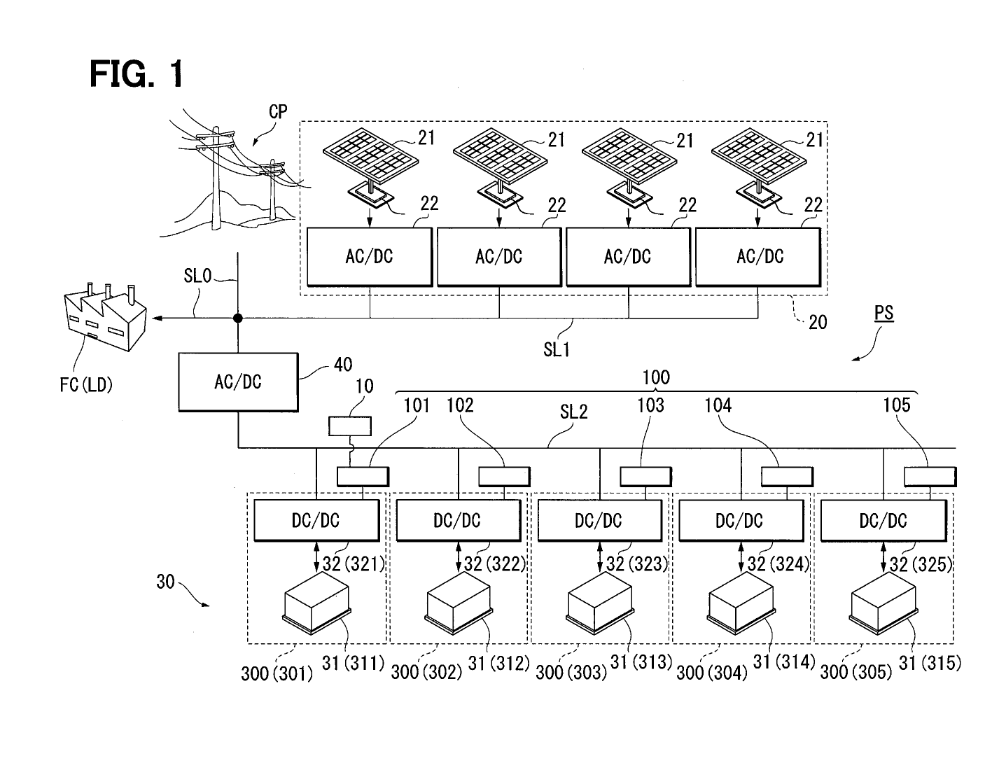

Referring to FIG. 1, a battery system 30 which a controller 100 controls will be explained, hereinafter. The battery system 30 is a part of power supply system PS for supplying an electric power to a factory FC.

The factory FC receives an electric power supply from an electric power system CP which is a commercial power source. The electric power system CP and the factory FC are connected through an electric power supply line SL0 which is an alternating current bus line. The factory FC receives three-phase alternating current of 200V from the electric power system CP through the electric power supply line SL0. The power use equipment (load) installed in the factory FC are operated with the electric power supplied from the electric power system CP. In the following description, the power use equipment installed in the factory FC will be referred to as “load LD.”

The power supply system PS is connected to the electric power supply line SL0 which connects the electric power system CP and the factory FC. The power supply system PS supplies an auxiliary electric power to the load LD through the electric power supply line SL0, and controls the electric power which supplies from the electric power system CP to the load LD. The power supply system PS has a high-order controller 10, a solar energy power generation system 20, the battery system 30, and a system interconnection inverter 40.

The high-order controller 10 is a computer system which controls the power supply system PS. The high-order controller 10 controls the battery system 30 based on the electric power generation of the solar energy power generation system 20 and the electric power consumption of the load LD, so that the battery system 30 is properly charged or discharged.

Specifically, when it is determined that the battery system 30 is necessary to be charged, the high-order controller 10 transmits signals indicative of a charging request and a target charge amount to the controller 100. When it is determined that the battery system 30 is necessary to supply the electric power to the load LD, the high-order controller 10 transmits signals indicative of a discharging request and a target discharge amount to the controller 100. Specific operations of the controller 100 and the battery system 30 will be explained later in detail.

The solar energy power generation system 20 converts the solar energy into the electric power which is supplied to the load LD. The electric power generated by the solar energy power generation system 20 is supplied to the load LD through an electric power supply line SL1 and the electric power supply line SL0. The electric power supply line SL1 is an alternating current bus line of which one end is connected to the electric power supply line SL0.

The solar energy power generation system 20 is provided with a solar panel 21 and an inverter 22. The solar panel 21 converts the solar energy into the electric power. A plurality of solar panels 21 is disposed on a roof of the factory FC.

The inverter 22 is a power conversion apparatus for converting the direct current power generated by the solar panel 21 into the three-phase alternating current power of 200 V. The converted three-phase alternating current power is supplied to the electric power supply line SL1. The inverter 22 is provided to each solar panel 21. As shown in FIG. 1, in the present embodiment, four sets of the solar panels 21 and the inverter 22 are connected to electric power supply line SL1 in parallel. The number of the solar panel 21 and the inverters 22 can be increased or decreased according to the scale of the factory FC and the performance of the solar panel 21.

During daytime, the electric power is supplied to the load LD from the solar energy power generation system 20. Thereby, the electric power supply from the electric power system CP to the load LD is suppressed, so that the electric charges can be reduced.

The battery system 30 is an apparatus for temporarily charging the electric power which was not consumed by the load LD. In a time zone where the power consumption by the load LD is large, the electric power supplied to the load LD from the electric power system CP can be suppressed by supplying the charged electric power to the load LD.

The electric power of the battery system 30 is supplied to the load LD through an electric power supply line SL2 and the electric power supply line SL0. The Electric power supply line SL2 is a direct-current bus line. The electric power supply line SL2 is connected to the electric power supply line SL0 and the electric power supply line SL1 through a system interconnection inverter 40.

The battery system 30 is provided with five battery devices 300. These battery devices 300 are connected in parallel to the electric power supply line SL2. Each battery device 300 is provided with a battery 31 and a DC-DC converter 32. The battery 31 and the DC-DC converter 32 are accommodated in a single housing as a unit. The number of the battery devices 300 can be changed according to the scale of the factory FC and the capacity of the battery 31, etc.

The battery 31 is a secondary battery, such as a lithium ion battery and a nickel hydride battery. The DC-DC converter 32 is a power conversion apparatus for increasing the direct current power of the battery 31, and supplying the direct current power to the electric power supply line SL2 (electric discharge). Moreover, the DC-DC converter 32 also has a function which decreases the direct current power flowing through the electric power supply line SL2, and supplies the direct current power to the battery 31 (electric charging). That is, the DC-DC converter 32 adjusts the voltage between the electric power supply line SL2 and the battery 31.

The system interconnection inverter 40 is a power conversion apparatus which changes the direct current power from the electric power supply line SL2 into the alternating-current power. The system interconnection inverter 40 supplies the alternating-current power to the electric power supply line SL0. Also, the system lo interconnection inverter 40 is a power conversion apparatus which changes the alternating-current power from the electric power supply line SL0 and the electric power supply line SL1 into the direct current power. The system interconnection inverter 40 supplies the direct current power to the electric power supply line SL2. That is, the system interconnection inverter 40 supplies the electric power interactively between the electric power supply line SL0 and the electric power supply line SL1, and the electric power supply line SL2.

The controller 100 will be described, hereinafter. The controller 100 is a computer system which controls the operation of the battery system 30. The controller 100 is comprised of one master control unit 101 and four slave control units 102, 103, 104, 105. Each control unit has a CPU, a ROM, a RAM, and an input/output interface.

The master control unit 101 controls the DC-DC converter 32 which one of the battery devices 300 has. Moreover, the master control unit 101 communicates with the slave control units 102, 103, 104, 105, whereby the battery system 30 is controlled. The master control unit 101 is accommodated in a housing of the battery device 300. The master control unit 101 operates by receiving the electric power from a power unit (not shown) which the battery device 300 has.

The slave control unit 102 controls the DC-DC converter 32 which another battery device 300 has. The slave control unit 102 is accommodated in a housing of the battery device 300. The slave control unit 102 operates by receiving the electric power from the power unit (not shown) which the battery device 300 has.

With respect to the other slave control units 103, 104, 105, each control unit is accommodated in the housing of the battery devices 300. In other words, each of the battery devices 300 accommodates one of the master control unit 101 and the slave control units 102, 103, 104, 105. The DC-DC converter 32 is controlled by the control units.

In the following description, the battery device 300 accommodating the master control unit 101 will be described as “the battery device 301.” Moreover, the DC-DC converter 32 which the battery device 301 has will be described as “the DC-DC converter 321”, and the battery 31 connected to the DC-DC converter 321 will be described as “the battery 311.”

Similarly, the battery device 300 accommodating the slave control unit 102 will be described as “the battery device 302.” Moreover, the DC-DC converter 32 which the battery device 302 has will be described as “the DC-DC converter 322”. The battery 31 connected to the DC-DC converter 322 will be described as “the battery 312.” The battery device 300 accommodating the other slave control units 103, 104, 105, and the DC-DC converter 32 and the battery 31 which the battery device 300 has which stored other slave control units will be described in similar way.

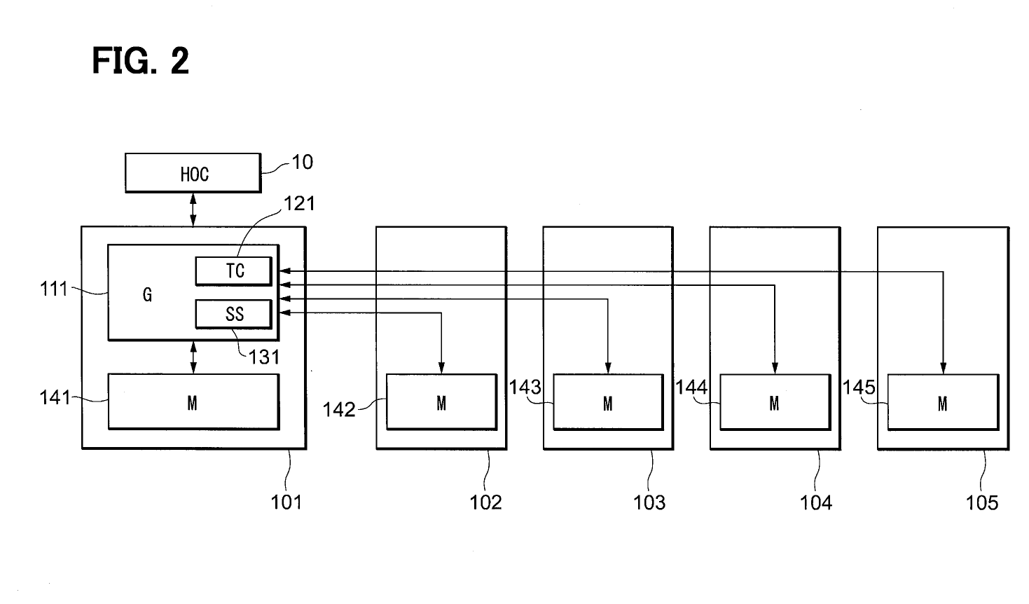

As shown in FIG. 2, the master control unit 101 has a generalization part 111 and a management part 141. The management part 141 is a control block for controlling the operation of the DC-DC converter 321, and manages the input/output of the electric power in the battery 311. The management part 141 computes and holds the electric energy (charging rate P1, hereafter) currently charged in the battery 311 based on the voltage between the output terminals of the battery 311, and the integral power consumption (coulomb count) of the battery 311.

Moreover, the management part 141 controls the DC-DC converter 321 based on control signals transmitted from the generalization part 111. The management part 141 controls the electric charge and the electric discharge of the battery 311.

The generalization part 111 is a control block for communicating with the management part 141 and the management parts 142, 143, 144, 145. The generalization part 111 has a target setting part 121 and a stop selection part 131. The functions of the above parts will be described later.

The slave control unit 102 does not have the above generalization parts, but has only the management part 142 as a functional control block. The management part 142 is a control block which has the same function as the management part 141 of the master control unit 101. The management part 142 controls the operation of the DC-DC converter 322, and manages the input/output of the electric power in the battery 312. Moreover, the management part 142 computes and holds the electric energy (charging rate P2, hereafter) currently charged in the battery 312. The management part 142 controls the DC-DC converter 322 based on control signals transmitted from the generalization part 111. The management part 142 controls the electric charge and the electric discharge of the battery 312.

The other slave control units 103, 104, 105 have the same configuration as the slave control unit 102. Each of the slave control units 103, 104, 105 has a management part 143, 144, 145 as a functional control block. Each management part 143, 144, 145 holds the electric energy (charging rate P3, P4, P5) currently charged in the battery 313, 314, 315. Each management part 143, 144, 145 controls the DC-DC converter 323, 324, 325 based on control signals transmitted from the generalization part 111. The management part 143, 144, 145 controls the electric charge and the electric discharge of the battery 313, 314, 315.

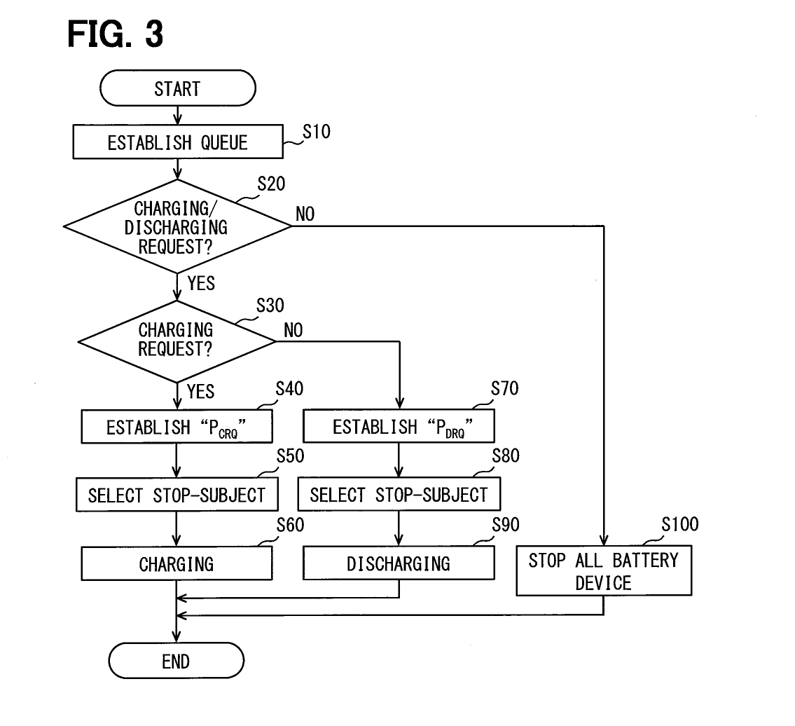

The specific function of each control block, and the processing performed by the controller 100 will be described, hereinafter. The processing shown in FIG. 3 is repeatedly performed by the controller 100 every 30 minutes. Moreover, the processing is started at every hour sharp and half past every hour sharp. A time period from starting of S10 until thirty minutes has elapsed is referred to as “charge-and-discharge period TM”, hereinafter.

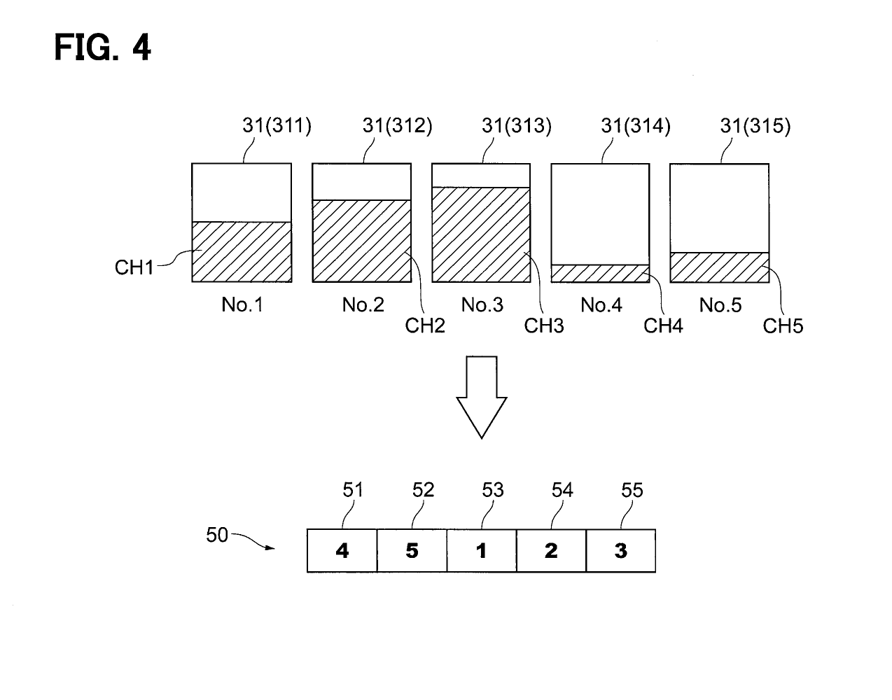

The generalization part 111 makes reference numbers “1”, “2”, “3”, “4”, “5” corresponding to the batteries 311, 312, 313, 314, 315, respectively. The generalization part 111 has a first storing part 51, a second storing part 52, a third storing part 53, a fourth storing part 54, and a fifth storing part 55 for storing the above reference numbers “1”, “2”, “3”, “4”, “5” with an order (refer to FIG. 4). One reference number is stored in each storing part.

In S10, the generalization part 111 generates a queue 50. The queue 50 is an aggregation of the reference numbers stored in the first storing part 51, the second storing part 52, the third storing part 53, the fourth storing part 54, and the fifth storing part 55 in order.

Before generating the queue 50, the generalization part 111 communicates with each management part to obtain the charging rates P1, P2, P3, P4, P5. The generalization part 111 stores the reference number corresponding to the battery 31 of which charging rates Pₙ (n: 1-5) is smallest in the first storing part 51. FIG. 4 shows that the charging rate P4 of the battery 314 is smallest. Therefore, the reference number “4” corresponding to the battery 314 is stored in the first storing part 51.

Then, the reference number “5” corresponding to the battery 31 of which charging rates is second smallest is stored in the second storing part 52. The reference number “1” corresponding to the battery 31 of which charging rates is third smallest is stored in the third storing part 53. Similarly, the reference number “2” corresponding to the battery 31 of which charging rates is fourth smallest is stored in the fourth storing part 54. The reference number “2” corresponding to the battery 31 of which charging rates is largest is stored in the fifth storing part 55.

In the example shown in FIG. 4, the sequence of the reference numbers in order of “4”, “5”, “1”, “2”, “3” is generated as the queue 50. The queue 50 indicates the order of the batteries 311, 312, 313, 314, 315 of which charged electric energy is smaller.

In S20, the generalization part 111 determines whether a charging request or a discharging request is transmitted from the high order controller 10. When neither the charging request nor the discharging request is transmitted, the procedure proceeds to S100. In S100, all of the battery devices 300 are stopped. That is, for thirty minutes (charge-and-discharge period TM), the charge and discharge of the battery system 30 are not performed. The standby energy which the battery system 30 consumes becomes substantially zero.

When the answer is YES in S20, the procedure proceeds to S30. In S30, it is determined whether the charging request is transmitted from the high order controller 10. When the answer is YES in S30, the procedure proceeds to S40.

In S40, the generalization part 111 receives a target charge amount (target charge amount P_{CRQ}) from the high order controller 10, and stores it in the target setting part 121. The target charge amount P_{CRQ} stored in the target setting part 121 corresponds to a totaled value of the electric energy charged in the whole battery system 30.

According to the present embodiment, all of the batteries 311, 312, 313, 314, 315 are not charged. One of the batteries 31 is charged. Specifically, a part of the battery devices 300 are stopped, and the other battery devices 300 are charged. In S50, the stop selection part 131 selects the battery device 300 to be stopped.

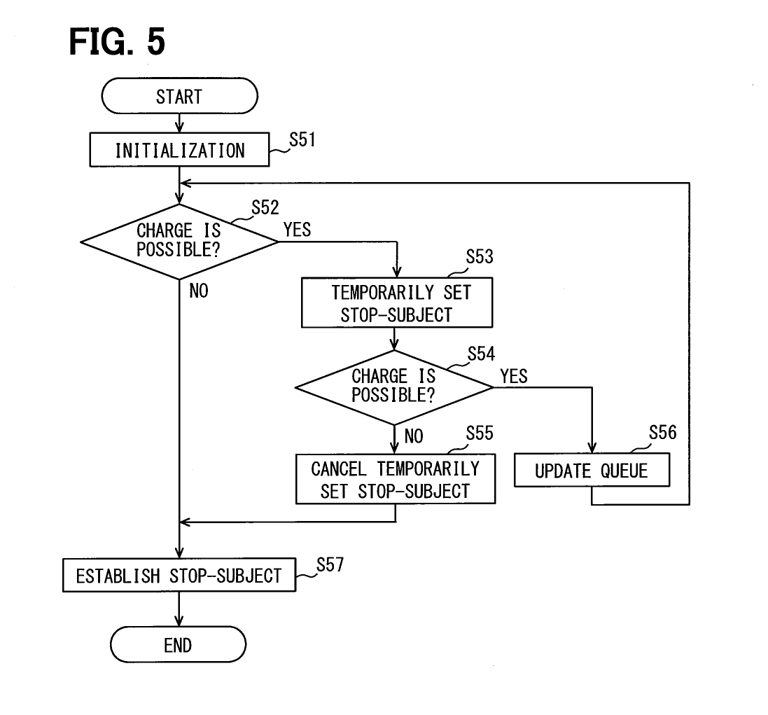

Referring to FIG. 5, a specific processing performed by the stop selection part 131 in S50 will be explained.

In S51, all of five values of state variable γn (n=1-5) are established as “1” as an initialization. The state variable γn is “0” or “1”. The suffix “n” indicates the reference number of the battery 31. When the battery device 300 has the battery 31 of which reference number is “n” and the battery device 300 is temporarily set as a stop-subject, the corresponding state variable γn is “0”. Moreover, when the battery device 300 is temporarily set as an operation-subject, the corresponding state variable γn is set to “1”.

In S52, when all batteries 31, of which reference numbers are stored in the queue 50, are charged, it is determined whether the electric energy which can be charged during the charge-and-discharge period TM exceeds the target charge amount P_{CRQ}. That is, it is determined whether there is enough electrical space for charging the target charge amount P_{CRQ}. The determination is conducted based on the following formula (1).

$$α < {\sum }_{n = 1}^{5} {γ}_{n} {Wc}_{n} Δ t - {P}_{CRQ} \qquad ( 1 )$$

In the above formula (1), “Δt” represents the charge-and-discharge period TM (30 minutes), and “Wcₙ” represents electric power (unit: kW) which is necessary to fully charge the battery 31 of which reference number is “n”, during the charge-and-discharge period TM. “Wcₙ” is established based on following formulas (2) and (3).

$$\begin{matrix}{Wc}_{n} = {W}_{DC} ( {P}_{n} + {W}_{DC} Δ t \leq P {max}_{n} ) & ( 2 ) \\ {Wc}_{n} = \frac{P {max}_{n} - {P}_{n}}{Δ t} ( {P}_{n} + {W}_{DC} Δ t > P {max}_{n} ) & ( 3 )\end{matrix}$$

“W_{DC}” represents the rated power of the DC-DC converter 32. Moreover, “Pmaxₙ” represents the electric energy (maximum charged amount of the battery 31) of the battery 31 of which reference number is “n”.

As shown in the formula (2), when the charging rate Pₙ of the battery 31 is small enough and it is possible to continue the charging the battery 31 at the rated power of the DC-DC converter 32 during the charge-and-discharge period TMs, the value of W_{DC} is established as Wcₙ. Meanwhile, as shown in the formula (3), when the charging rate Pₙ of the battery 31 is relatively large and an additional electric charging is small, the value of Wcₙ is obtained by dividing the electric energy (Pmaxₙ−Pₙ) by the charge-and-discharge period TM.

The first term of right hand side of the formula (1) shows total electric energy (unit: kWh) which is charged in the operating battery devices 30 during the charge-and-discharge period TM. When the formula (1) is not satisfied, it can be estimated that there is not enough electric space for charging the target charge amount P_{CRQ} to the battery system 30. In this case, the procedure proceeds to S57.

A threshold “α” is a positive value which is established in view of that the charging rate Pₙ transmitted from the management parts 141-145 of each battery device 300 may include an error. Due to the threshold “α”, it is avoided that a part of batteries 31 is over-charged.

In S57, the battery device 300 to be stopped as the stop-subject is established. Specifically, among five battery devices 300, the battery device 300 including the battery 31 of which reference number is not stored in the queue 50 will be stopped.

When the process in S52 is performed first, all of the values of state variable γn (n=1-5) are “1”. All of the reference numbers (1-5) are stored in the queue 50. That is, all of the battery devices 300 are operated. In such a condition, when the formula (1) is not satisfied in S52, all of the battery devices 300 will be stopped.

When the formula (1) is satisfied in S52, the procedure proceeds to step S53. In S53, the reference number stored in the fifth storing part 55 is obtained, and the value of state variable γn corresponding to the reference number is established as “0”. That is, the battery device 300 including the battery 31 of which charging rate are largest is temporarily set as the battery device 300 to be stopped. In the example shown in FIG. 4, the reference number stored in the fifth storing part 55 is “3”. Thus, the value of state variable γ3 is set to “0”, and the battery device 303 including the battery 313 is temporarily set as the battery device to be stopped.

In S54, it is determined whether the formula (1) is satisfied. When the answer is NO in S54, the procedure proceeds to S55. In this case, the target charge amount P_{CRQ} cannot be charged in the battery system 30 if a part of the battery devices 300 is brought to be stopped. That is, it is appropriate that the battery device 300 will not be brought into be stopped, which is temporarily set as the battery device 300 to be stopped.

Thus, in S55, the state variable γn is set to “1”. That is, the temporary setting as the stop-subject is canceled. Then, the procedure proceeds to S57 in which the battery device 300 to be stopped as the stop-subject is established.

When the answer is YES in S54, the procedure proceeds to S56. In this case, the target charge amount P_{CRQ} can be charged in the battery system 30 even if a part of the battery devices 300 is the stop-subject. That is, there is no problem even if the battery device 300 is stopped, which is temporarily set as the stop-subject in S53.

In S56, the queue 50 is updated. Specifically, the reference number stored in the fifth storing part 55 is deleted from the queue 50, and the reference number stored in the fourth storing part 54 is stored in the fifth storing part 55. Then, the reference number stored in the third storing part 53 is stored in the fourth storing part 54. Regarding the third storing part 53, the second storing part 52 and the first storing part 51, the same process is performed. Then, the reference number stored in the first storing part 51 is deleted.

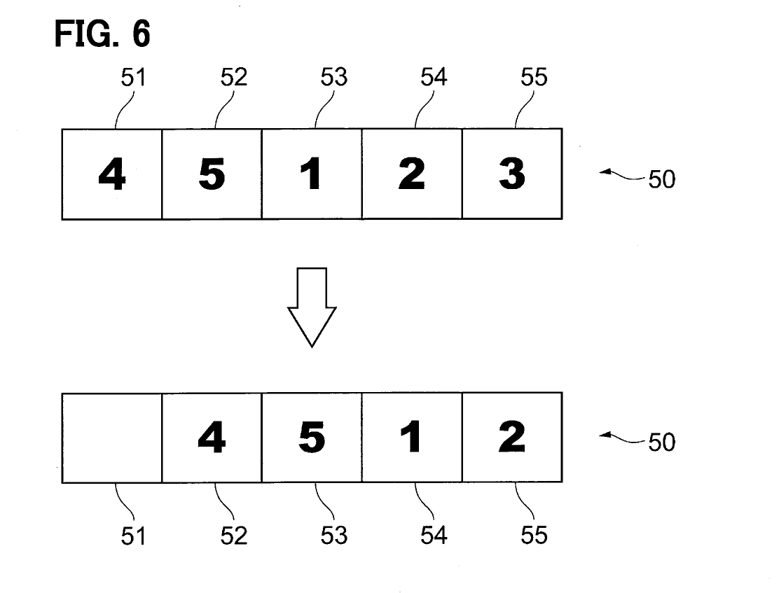

That is, as shown in FIG. 6, the reference number corresponding to the battery 31 of which charging rates is largest is deleted from the queue 50. The remaining reference numbers are shifted one by one from the first storing part 51 to the fifth storing part 55.

After the queue 50 is updated, the procedure goes back to S52. As a result, at the time when the processing shown in FIG. 5 is completed, the number of the battery system 30 which is the stop-subject is largest as long as the target charge amount P_{CRQ} can be charged in the battery system 30. That is, as long as the target charge amount P_{CRQ} can be charged, the battery device 300 is the stop-subject as many as possible.

In S60, all of the battery devices 300 which are the stop-subject are stopped. That is, each of the battery devices 300 which is the stop-subject is shut down, so that the standby energy is not consumed.

Further, in S60, with respect to the battery devices 300 which are not the stop-subjects, the electric charging to the battery 31 is started. That is, the electric charging is started only for the battery 31 of which reference number is stored in the queue 50. At this time, the value of the electric power (unit: kW) supplied from the DC-DC converter 32 to the battery 31 is equal to “Wcₙ” in the formula (1).

The generalization parts 111 controls the management parts 141, 142, 143, 144, 145 so that the electric power supplied from the DC-DC converter 32 to the battery 31 becomes “Wcₙ”.

As described above, according to the present embodiment, when the battery system 30 is charged, all battery devices 300 are not always operated. A part of the battery devices 300 is stopped based on the target charge amount P_{CRQ}. The other battery device 300 which is not stopped is charged. The standby energy of the stopped battery device 300 becomes substantially zero. The operating efficiency of the whole battery system 30 can be improved.

Moreover, the battery device 300 to be stopped is selected based on the target charge amount P_{CRQ}. For this reason, even if a part of the battery devices 300 is stopped, the electric energy charged in the whole battery system 30 does not run short.

Furthermore, the stop selection part 131 selects the battery device 300 as the stop-subject, which has the battery 31 of which charging rates is larger. In the example shown in FIG. 4, the stop selection part 131 selects the battery device 303, the battery device 302, the battery device 301, the battery device 305, and the battery device 304 in this order as the stop-subject. That is, as long as the target charge amount P_{CRQ} can be charged, the battery device 300 can be stopped as many as possible.

When no charging request is transmitted from the high order controller 10 in S30, the procedure proceeds to S70.

In S70, the generalization part 111 receives a target discharge amount (target discharge amount P_{DRQ}”) from the high order controller 10, and stores it in the target setting part 121. The target discharge amount P_{DRQ} stored in the target setting part 121 corresponds to a totaled value of the electric energy discharged from the whole battery system 30.

According to the present embodiment, all of the batteries 311, 312, 313, 314, 315 are not discharged. One of the batteries 31 is discharged. Specifically, a part of the battery devices 300 are stopped, and the other battery devices 300 are discharged. In S80, the stop selection part 131 selects the battery device 300 to be stopped.

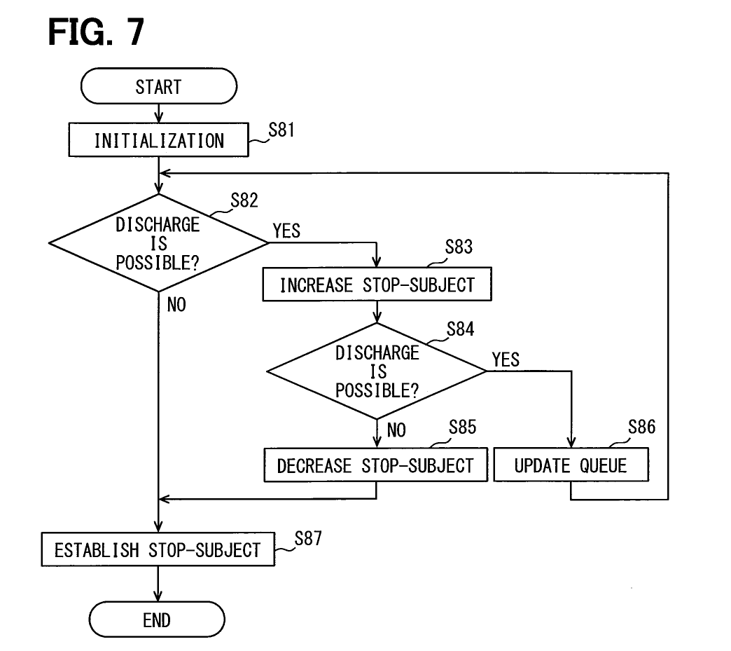

Referring to FIG. 7, a specific processing performed by the stop selection part 131 in S80 will be explained.

In S81, all of five values of state variable γn (n=1-5) are established as “1” as an initialization.

In S82, when all batteries 31, of which reference numbers are stored in the queue 50, are discharged, it is determined whether the electric energy which can be discharged during the charge-and-discharge period TM exceeds the target discharge amount P_{DRQ}. That is, it is determined whether there is enough charging rate for discharging the target discharge amount P_{DRQ}. The determination is conducted based on the following formula (4).

$$α < {\sum }_{n = 1}^{5} {γ}_{n} {Wd}_{n} Δ t - {P}_{DRQ} \qquad ( 4 )$$

In the formula (4), “Wdₙ” represents electric power (unit: kW) which is discharged from the battery 31 of which reference number is “n”, during the charge-and-discharge period TM. “Wdₙ” is established based on following formulas (5) and (6).

$$\begin{matrix}{Wd}_{n} = {W}_{DC} ( {P}_{n} - {W}_{DC} Δ t \geq P {min}_{n} ) & ( 5 ) \\ {Wd}_{n} = \frac{{P}_{n}}{Δ t} ( {P}_{n} - {W}_{DC} Δ t < P {min}_{n} ) & ( 6 )\end{matrix}$$

As described above, “W_{DC}” represents the rated power of the DC-DC converter 32. In the above formulas, “Δt” represents the charge-and-discharge period TM (30 minutes).

As shown in the formula (5), when the charging rate Pₙ of the battery 31 is large enough and it is possible to continue the discharging the battery 31 at the rated power of the DC-DC converter 32 during the charge-and-discharge period TMs, the value of W_{DC} is established as Wdₙ. Meanwhile, as shown in the formula (6), when the charging rate Pₙ of the battery 31 is not enough, the value of Wdₙ is obtained by dividing the charging rate Pₙ by the charge-and-discharge period TM.

A threshold “Pminn” is a positive value which is established in view of that the charging rate Pₙ transmitted from the management parts 141-145 of each battery device 300 may include an error. That is, even if the electric energy actually charged in the battery 31 of which reference number “n” is less the charging rate Pₙ, the electric power which exceeds the discharge limit of the battery 31 is not discharged.

The first term of right hand side of the formula (4) shows total electric energy (unit: kWh) which is discharged in the operating battery devices 300 during the charge-and-discharge period TM. When the formula (4) is not satisfied, it can be estimated that there is not enough electric energy for discharging the target discharge amount P_{DRQ} from the battery system 30. In this case, the procedure proceeds to S87.

A threshold “α” is a positive value which is established in view of that the charging rate Pₙ transmitted from the management parts 141-145 of each battery device 300 may include an error. Due to the threshold “α”, it is avoided that a part of batteries 31 is over-discharged.

In S87, the battery device 300 to be stopped as the stop-subject is established. Specifically, among five battery devices 300, the battery device 300 including the battery 31 of which reference number is not stored in the queue 50 is stopped.

When the process in S82 is performed first, all of the values of state variable γn (n=1-5) are “1”. All of the reference numbers (1-5) are stored in the queue 50. That is, all of the battery devices 300 are operated. In such a condition, when the formula (4) is not satisfied in S82, all of the battery devices 300 are stopped in S87.

When the formula (4) is satisfied in S82, the procedure proceeds to step S83. In S83, the reference number stored in the first storing part 51 is obtained, and the value of state variable γn corresponding to the reference number is established as “0”. That is, the battery device 300 including the battery 31 of which charging rates is smallest is temporarily set as the battery device 300 to be stopped. In the example shown in FIG. 4, the reference number stored in the first storing part 51 is “4”. Thus, the value of state variable γ4 is set to “0”, and the battery device 304 including the battery 314 is temporarily set as the battery device to be stopped.

In S84, it is determined whether the formula (4) is satisfied. When the answer is NO in S84, the procedure proceeds to S85. In this case, the target discharge amount P_{DRQ} cannot be discharged from the battery system 30 if a part of the battery devices 300 is brought to be stopped. That is, it is appropriate that the battery device 300 is not be stopped, which is temporarily set as the stop-subject in S83.

Thus, in S85, the state variable γn is set to “1”. That is, the temporary setting as the stop-subject is canceled. Then, the procedure proceeds to S87 in which the battery device 300 to be stopped as the stop-subject is established.

When the answer is YES in S84, the procedure proceeds to S86. In this case, the target discharge amount P_{DRQ} can be discharged from the battery system 30 even if a part of the battery devices 300 is the stop-subject. That is, there is no problem even if the battery device 300 is stopped, which is temporarily set as the stop-subject in S83.

In S86, the queue 50 is updated. Specifically, the reference number stored in the first storing part 51 is deleted from the queue 50, and the reference number stored in the second storing part 52 is stored in the first storing part 51. Then, the reference number stored in the third storing part 53 is stored in the second storing part 52. Regarding the third storing part 53, the fourth storing part 54 and the fifth storing part 55, the same process is performed. Then, the reference number stored in the fifth storing part 55 is deleted.

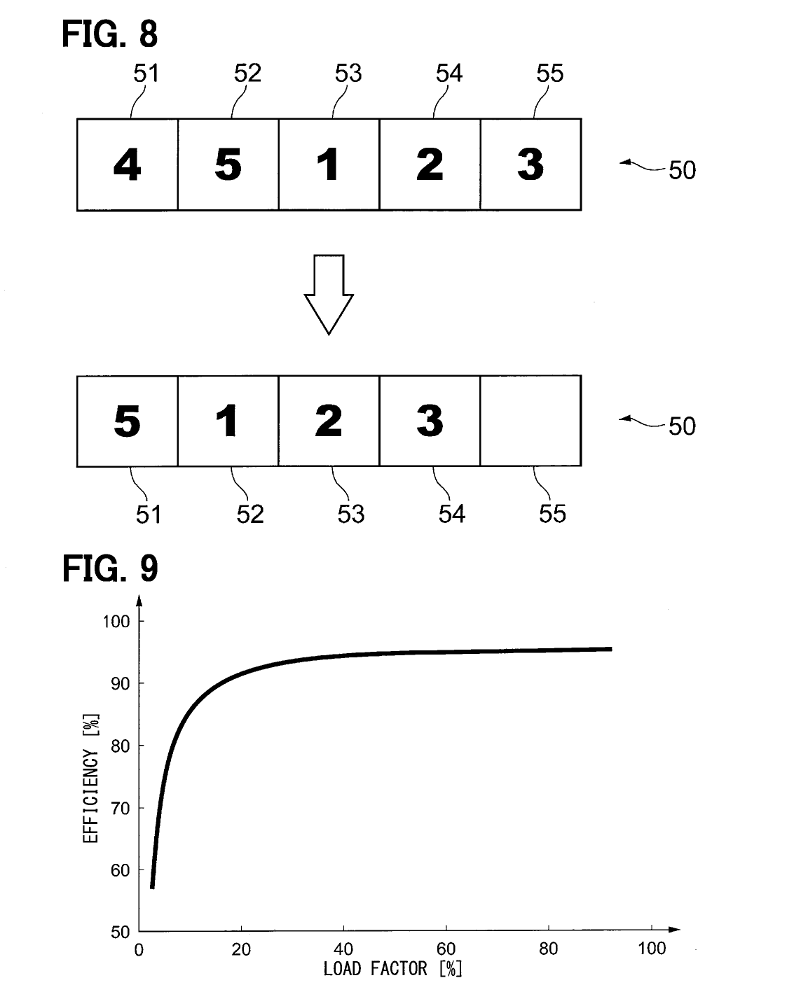

That is, as shown in FIG. 8, the reference number corresponding to the battery 31 of which charging rates is smallest is deleted from the queue 50. The remaining reference numbers are shifted one by one from the fifth storing part 55 to the first storing part 51.

After the queue 50 is updated, the procedure goes back to S82. As a result, at the time when the processing shown in FIG. 7 is completed, the number of the battery system 30 which is the stop-subject is largest as long as the target discharge amount P_{DRQ} can be discharged from in the battery system 30. That is, as long as the target discharge amount P_{DRQ} can be discharged, the battery device 300 is the stop-subject as many as possible.

In S90, all of the battery devices 300 which are the stop-subject are stopped. That is, each of the battery devices 300 which is the stop-subject is shut down, so that the standby energy is not consumed.

Further, in S90, with respect to the battery devices 300 which are not the stop-subjects, the electric discharging from the battery 31 are started. That is, the electric discharging is started only from the battery 31 of which reference number is stored in the queue 50. At this time, the value of the electric power (unit: kW) which the DC-DC converter 32 can derive from the battery 31 is equal to “Wdₙ” in the formula (4).

The generalization parts 111 controls the management parts 141, 142, 143, 144, 145 so that the electric power which the DC-DC converter 32 can drive from the battery 31 becomes “Wdₙ”.

As described above, according to the present embodiment, when the battery system 30 is discharged, all battery devices 300 are not always operated. A part of the battery devices 300 is stopped based on the target discharge amount P_{DRQ}. The other battery devices 300 which are not stopped are discharged. The standby energy of the stopped battery device 300 becomes substantially zero. The operating efficiency of the whole battery system 30 can be improved.

Moreover, the battery device 300 to be stopped is selected based on the target discharge amount P_{DRQ}. For this reason, even if a part of the battery devices 300 is stopped, the electric energy which is supplied from the whole battery system 30 to load LD does not run short.

Furthermore, the stop selection part 131 selects the battery device 300 as the stop-subject, which has the battery 31 of which charging rates is smaller. In the example shown in FIG. 4, the stop selection part 131 selects the battery device 304, the battery device 305, the battery device 301, the battery device 302, and the battery device 303 in this order as the stop-subject. That is, as long as the target discharge amount P_{DRQ} can be discharged, the battery device 300 can be stopped as many as possible.

As described above, according to the present embodiment, the battery system 30 is charged/discharged while a part of the battery devices 300 are stopped. Useless power consumption can be reduced. The operating efficiency of the whole battery system 30 can be improved. Referring to FIG. 9, a specific procedure will be described hereinafter.

FIG. 9 is a graph showing a relation between a load factor and an efficiency in the DC-DC converter 32. The “load factor” is a ratio of the electric power (electric power taken out from the battery 31) inputted into DC-DC converter 32 relative to the rated power W_{DC}. As the electric power taken out from the battery 31 becomes smaller, the load factor becomes smaller. As the electric power taken out from the battery 31 becomes larger, the load factor becomes larger. When the load factor is 100%, the electric power almost equal to the rated power W_{DC} can be taken out from the battery 31.

The “efficiency” is a ratio of the output electric power of the DC-DC converter 32 relative to the input electric power of the DC-DC converter 32. In a case that the electric power taken out from the battery 31, i.e., the input power to the DC-DC converter 32, is constant, as the efficiency is higher, the output power from the DC-DC converter 32 becomes larger. When the efficiency is low, the output power from DC-DC converter 32 will become smaller. When the efficiency is 100%, the electric power almost equal to the electric power taken out from the battery 31 is outputted from the DC-DC converter 32.

As shown in FIG. 9, as the load factor becomes larger, the efficiency becomes higher in the DC-DC converter 32. Moreover, when the load factor is 100%, the efficiency is the highest and is almost equal to 100%. That is, the electric power taken out from the battery 31 will be outputted without futility.

According to the present embodiment, when the battery system 30 is charged or discharged during the charge-and-discharge period TM, a part of the battery devices 300 are stopped and the remaining battery devices 300 are charged or discharged. Therefore, the electric power inputted into each battery 31 at the time of electric charging becomes larger, and the electric power outputted from each battery 31 at the time of electric discharging become larger. That is, the electric power flowing through the DC-DC converter 32 becomes larger than the case in which all battery devices 300 are operated. As a result, the DC-DC converter 32 can be operated at high efficiency, so that the operating efficiency of the whole battery system 30 is enhanced.

In the present embodiment, the queue 50 is established based on the charging rate Pₙ of each battery 31 in S10. However, the queue 50 may be established based on another information.

For example, the control unit 100 stores the number of charging times of each battery 51 in a specified period, and the queue 50 may be established in such a manner that the battery 51 of which charging times is smaller becomes the stop-subject. In this case, since the opportunity of full-charge is equal among all batteries 31, it can be avoided that a calculation error of the charging rate Pₙ becomes large.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A controller for a battery system which is provided with a plurality of battery devices, the controller comprising:
a target setting portion establishing a target charge/discharge amount which the battery system charges or discharges during a predetermined charge-and-discharge period; and
a stop selection portion selecting a part of the battery devices to be stopped based on the target charge/discharge amount, wherein
during the predetermined charge-and-discharge period, the part of the battery devices selected by the stop selection portion is stopped and a remaining part of the battery devices is charged or discharged.

2. A controller for a battery system according to claim 1, wherein
the stop selection portion selects the part of the battery devices to be stopped, in such a manner that a number of the selected battery devices becomes largest as long as the battery system can be charged or discharged.

3. A controller for a battery system according to claim 2, wherein
when the battery systems is charged during the charge-and-discharge period, the stop selection portion preferentially selects the part of the battery devices of which chargeable electric energy is smaller.

4. A controller for a battery system according to claim 2, wherein
when the battery systems is discharged during the charge-and-discharge period, the stop selection portion preferentially selects the part of the battery devices of which charged electric energy is smaller.
